(19) United States
(12) Patent Application Publication
(10) Pub. No.: US 2009/0182538 A1
(43) Pub. Date: Jul. 16, 2009

(54) MULTI-OBJECTIVE OPTIMUM DESIGN SUPPORT DEVICE USING MATHEMATICAL PROCESS TECHNIQUE, ITS METHOD AND PROGRAM

(75) Inventors: Hitoshi Yanami, Kawasaki (JP); Hirokazu Anai, Kawasaki (JP); Tsuneo Nakata, Kawasaki (JP); Naozumi Tsuda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/347,585

(22) Filed: Dec. 31, 2008

(30) Foreign Application Priority Data
Jan. 14, 2008 (JP) 2008-005105
Jun. 4, 2008 (JP) 2008-147332

(51) Int. Cl. G06F 17/10

(52) U.S. Cl. 703/2

(57) ABSTRACT

A unit 101 calculates a plurality of sets of objective functions of sample sets of input parameters. A unit 102 approximates the objective functions using a polynomial on the basis of the calculation result of the unit 101. A unit 103 calculates a logical expression indicating a logical relation between arbitrary two or three objective functions, of the plurality of mathematically approximated objective functions as an inter-objective function logical expression by a QE method. A unit 104 displays areas that the values of the objective functions can take as usable areas according to the inter-objective function logical expression. Units 105 and 106 determine an optimum set of design parameters by limiting the sets of design parameters to corresponding sets of design parameters in the neighborhood of a Pareto boundary on the basis of the Pareto boundary of an objective function recognized from the usable areas displayed.

### CROSS-REFERENCE TO RELATED ARTS

This application is based upon and claims the benefit of priority of the prior Japanese Application No. 2008-005105, filed on Jan. 14, 2008 and prior Japanese Application No. 2008-147332, filed on Jun. 4, 2008, the entire contents of which are incorporated herein by reference.

### FIELD

The present invention relates to a multi-objective optimum design support technique used in the design of a slider shape of a hard disk and the like.

### BACKGROUND

Along with the high-density/high capacity of a hard disk, a distance between a magnetic disks and a header has been more and more reduced. A slider design with a small amount of flying variation due to an altitude difference and a disk radius position is required.

As represented as 1601 in FIG. 1, a slider is installed in the top end lower part of an actuator 1602 moving on a magnetic disk in a hard disk and the position of a header is calculated on the basis of the shape of the slider 1601.

When determining the optimum shape of the slider 1601, an efficient calculation for simultaneously minimizing the function of flying height (1603 in FIG. 1), roll (1604) and pitch (1605), so-called multi-objective optimization is required.

Conventionally, instead of directly handling a multi-objective optimization problem, a single-objective optimization is performed, in which as shown as following mathematical expression 1, the linear sum f of terms is obtained by multiplying each objective function f_i by weight m_i and its minimum value is calculated.

f=m_{—}1*f_{—}1+ . . . +m_{—}t*f_{—}t [Mathematical expression 1]

Then, a slider shape in which a function f can be calculated in such a way that its value is minimized while parameters p, q, r and the like, for determining the slider shape S shown in FIG. 2 are modified little by little by a program, is calculated.

In the above equation, f depends on weight vector {m_i} In actual design, the minimum value of f against each modification value while further modifying {m_i} and a slider shape is determined by comprehensively determining the balance between its minimum value and {m_i}.

Methods for calculating a Pareto curved surface in multi-objective optimization (optimum curved surface), so called normal boundary intersection (NBI) and the like are also known.

Patent Document 1: Japanese Patent Application Laid-open No. 2002-117018

However, in the above-described conventional optimization technique of a single-objective function f, a flying calculation which takes much time must be repeated. In particular, when probing the fine part of a slider shape, the number of input parameters (corresponding to p, q, r and the like shown in FIG. 2) becomes around 20 and 10, 000 times or more of flying calculations becomes necessary. It takes very much time to optimize it, which is a problem.

For example, FIG. 3 is the operational flowchart of the prior art system. After specification setting (step S1801) and weight vector setting (step S1802), in the calculation of the optimization process of a single-objective function (step S1803) it is necessary to apply huge number of flying calculations to several-ten thousands of input parameter sets.

Furthermore, in this method, the minimum value of f (and a then input parameter value) depends on how to determine weight vector (m_{—}1, . . . , m_t). In actual design, a situation in which it is desired to optimize f against various sets of weight vectors and compare them frequently occurs. Since according to the above-described prior art it is necessary to do over again an optimization calculation accompanying an expensive flying calculation repeating steps S1804 to S1802 shown in FIG. 3 every time modifying weight vector. Therefore, the types of weight vectors to experiment are limited. It takes enormous time to output an optimum slider shape (optimum parameter set) (step S1806 in FIG. 3) after determining a final weight vector (step S1805 in FIG. 3).

Furthermore, since in the minimization of a function value f, only one point can be obtained on a Pareto curved surface at one time, it is difficult to predict the optimum relation among objective functions and also such information cannot be fed back to design, which are problems

Furthermore, in the prior art for calculating a Pareto curved surface by a numerical analysis method, it cannot be solved when a usable area is non-convex and an algorism cannot operate smoothly when a point (end point) being a source in the calculation of a Pareto curved surface is near, which are problems.

### SUMMARY

The aspect of the present invention presumes a design support device for supporting the determination of an optimum set of design parameters by inputting a plurality of sets of design parameters (input parameters), calculating a plurality of objective functions on the basis of a prescribed calculation and applying a multi-objective optimization process to the plurality of objective functions. The design parameters are, for example, parameters for determining the shape of a slider unit of a hard-disk magnetic storage device.

A sample-set objective function calculation unit (for example, 101 in FIG. 4) calculates a plurality of sets of objective functions of a prescribed number of sample sets of design parameters.

An objective function approximation unit (for example, 102 in FIG. 4) mathematically approximates an objective function on the basis of a prescribed number of sample sets of design parameters and a plurality of sets of objective functions calculated in relation to them. This objective function approximation unit approximates an objective function by conducting a multiple regression analysis using a polynomial by a multiple regression expression, for example, on the basis of a prescribed number of sample sets of design parameters and a plurality of sets of objective functions calculated in relation to them.

An inter-objective function logical expression calculation unit (for example, 103 in FIG. 4) calculates a logical expression indicating the logical relation between arbitrary two or three objective functions, of a plurality of mathematically approximated objective functions as an inter-objective function logical expression. This inter-objective function logical expression calculation unit eliminates the argument of the design parameter of, for example, arbitrary two or three objective functions, of a plurality of mathematically approximated objective functions by a quantifier elimination method (QE method) and calculates an inter-objective function logical expression.

A usable area display unit (for example, 104 in FIG. 4) displays an area that the value of two or three objective functions can take as a usable area on the basis of an inter-objective function logical expression.

A design support unit (for example, 105 and 106 in FIG. 4) supports design on the basis of the display of a usable area. This design support unit supports the determination of an optimum set of design parameters by limiting the application of a multi-objective optimization process to a set of design parameters corresponding to neighborhood of the Pareto boundary, for example, on the basis of the Pareto boundary of objective functions recognized from the usable area displayed by the usable area display unit.

The object and advantage of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 shows the slider of a hard disk.

FIG. 2 shows the parameters of a slider shape.

FIG. 3 is the operational flowchart of the prior art.

FIG. 4 shows the functional block configuration of the preferred embodiment of the present invention.

FIG. 5 is the operational flowchart of the overall process of the preferred embodiment of the present invention.

FIG. 6 is the operational flowchart of usable area display by a mathematical process (No.1).

FIG. 7 is the operational flowchart of usable area display by a mathematical process (No.2).

FIG. 8 shows examples of a sample set of input parameters 107 and each objective function value corresponding to it.

FIG. 9 shows an example of usable area display (No. 1).

FIG. 10 shows an example of usable area display (No. 2).

FIG. 11 shows the center range specifying operation of an input parameter.

FIGS. 12A and 12B show examples of usable area display (No. 3).

FIGS. 13A and 13B show the problems of the usable area display.

FIG. 14 shows how to improve the usable area display.

FIG. 15 is the operational flowchart of usable area display by a mathematical process (No.3).

FIGS. 16A and 16B show examples of usable area display (No.4).

FIGS. 17A and 17B show examples of usable area display (No.5).

FIG. 18 shows one example of the hardware configuration of a computer capable of realizing a system according to the preferred embodiment of the present invention.

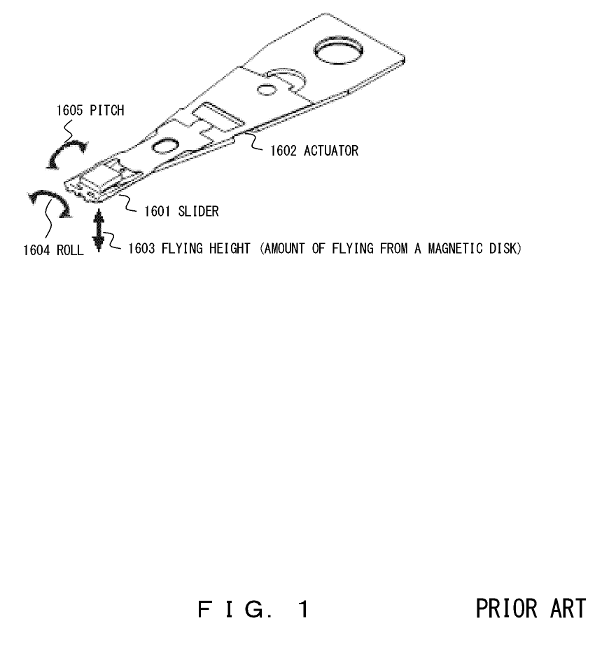

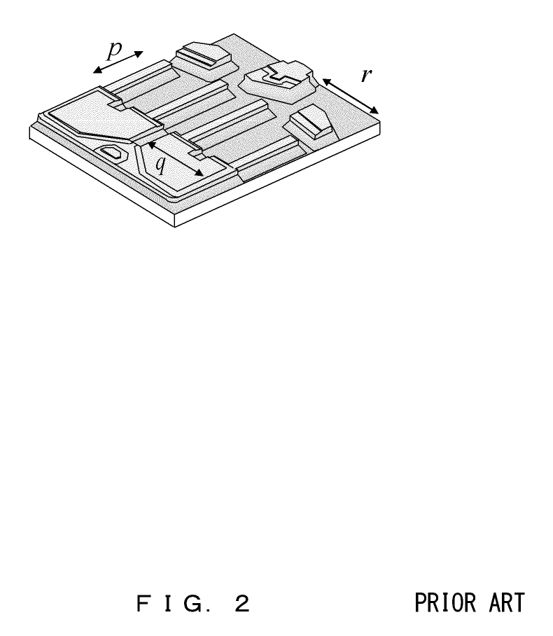

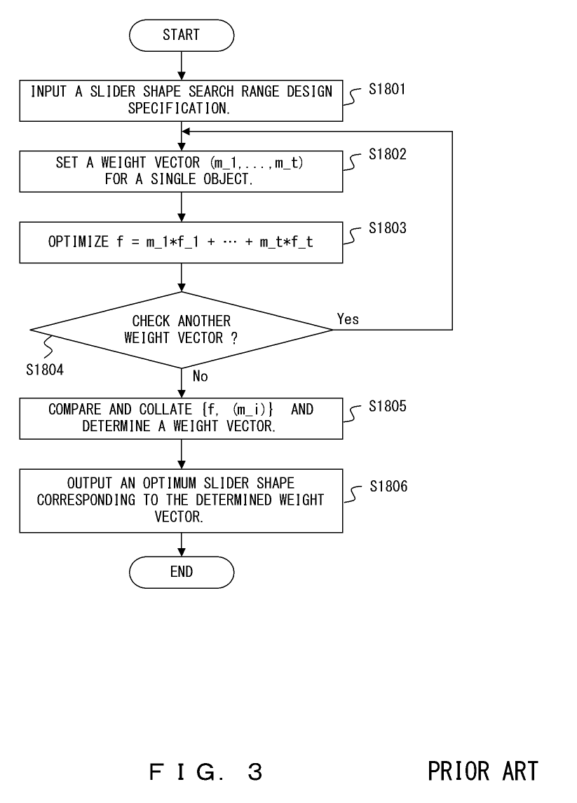

### DESCRIPTION OF EMBODIMENTS

The preferred embodiments of the present invention are described in detail below with reference to the drawings.

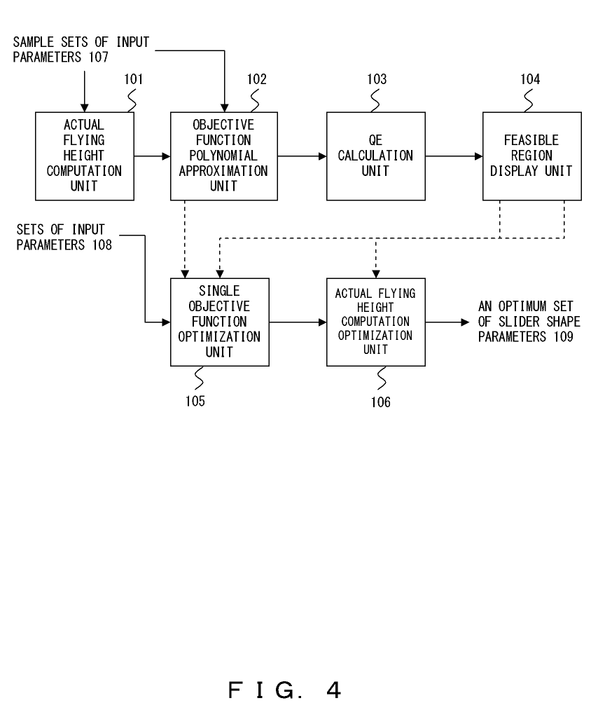

FIG. 4 shows the functional block configuration of the preferred embodiment of the present invention.

An actual flying calculation unit 101 inputs sample sets of the input parameters 107 for the slider shape of a hard disk, applies a slider flying calculation to each set and outputs each objective function value. In this case, the number of the sample sets of input parameters 107 is at most several hundreds.

An objective function polynomial approximation unit 102 approximates each objective function for the slider shape of each set calculated by the actual flying calculation unit 101 by performing a multiple regression analysis using a polynomial by a multiple regression expression.

A quantifier elimination (QE) unit 103 calculates arbitrary two inter-objective function logical expression by a QE method on the basis of each objective function polynomial calculated by the objective function polynomial approximation unit 102 and the constraint condition of each parameter value of the input parameter sample sets 107 (input parameter sets 108).

A usable area display unit 104 displays the usable area of an objective function on a computer display, which is not in particular shown in FIG. 4, on the basis of arbitrary two or more inter-objective function logical expressions calculated by the QE calculation unit 103.

A single objective function optimization unit 105 calculates the single objective function value obtained as the weighted linear sum of the objective functions, of the input parameter sets 108 on the basis of each objective function polynomial calculated by the objective function polynomial approximation unit 102 and the weight vector determined by a user on the usable area display unit 104 and calculates the input parameter set 108 candidate whose single objective function value becomes a minimum. The number of input parameter sets 108 is 10,000 to 20,000 sets.

An actual flying calculation optimization unit 106 outputs input parameter sets 108 whose single objective function value becomes a minimum by applying a detailed flying calculation to the input parameter set 108 candidates whose single objective function value calculated by the single objective function optimization unit 105 becomes a minimum and calculating a single objective function value obtained as the weighted linear sum of objective functions calculated on the basis of it. In this case, for each objective function, one obtained by the actual flying calculation is used, and for the weight vector, the same one as used in the single objective function optimization unit 105 or one obtained by modifying it somewhat is used.

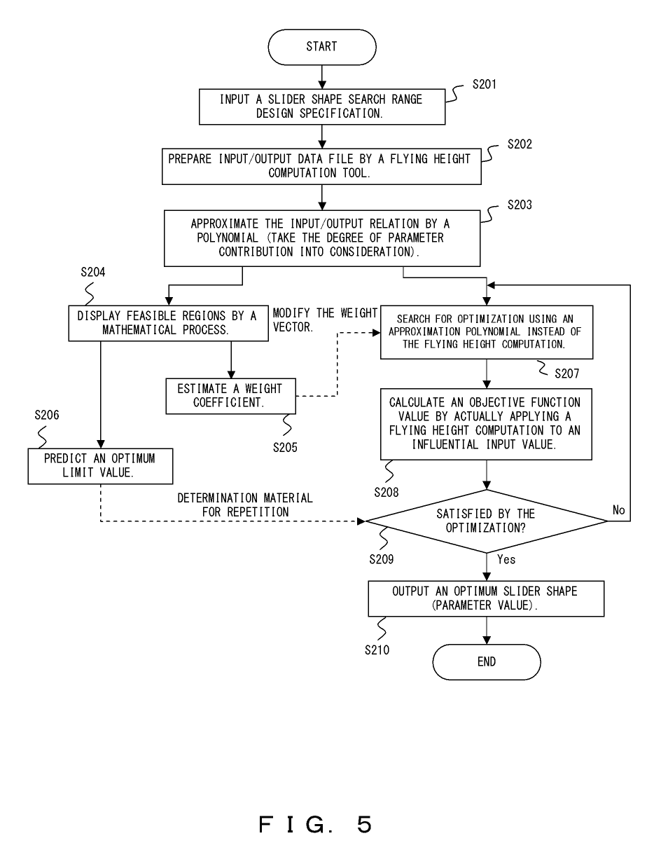

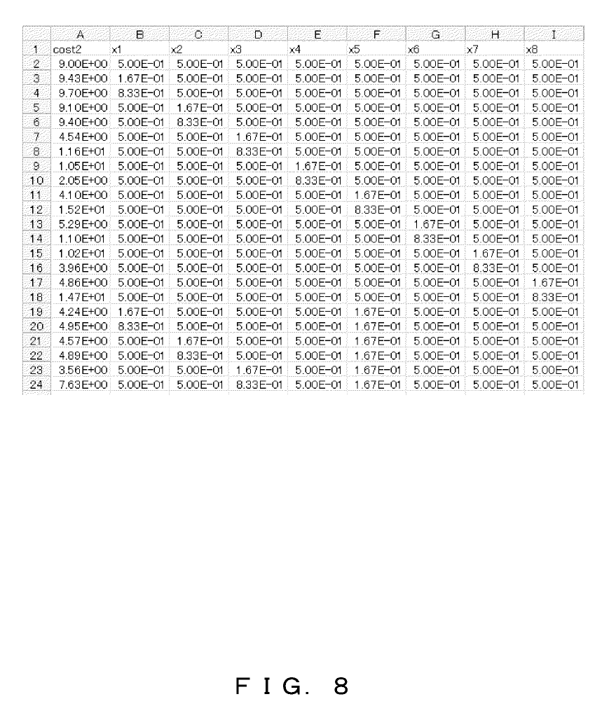

The operation of the preferred embodiment of the present invention having the above configuration is described below according to the operational flowcharts shown in FIGS. 5˜7, and 15 and with reference to FIGS. 8˜11˜14, 16A and 16B and 17A and 17B.

FIG. 5 is the operational flowchart of the overall process of the preferred embodiment of the present invention executed by a system having the functional block configuration shown in FIG. 4.

Firstly, the actual flying calculation unit 101 inputs several hundreds of input parameter sample sets 107 as the design specification about the search range of a slider shape (step S201 in FIG. 5), applies a slider flying calculation to each set and outputs each objective function value (step S202 in FIG. 5).

Thus, for example, the input parameter sample sets 107 as shown in FIG. 8 and the data file of their objective function values are made out. In FIG. 8, values in a column indicated as x1˜x8 are the input parameter sample sets 107 and values in columns indicated as cost2 are the value group of a certain objective function.

Then, the objective function polynomial approximation unit 102 approximates each objective function of the slider shape by applying a multiple regression analysis to the data file consisting of the input parameter sample sets 107 and each objective function value calculated for each set using a polynomial by a multiple regression expression (step S203 in FIG. 5).

As this result, the polynomial of objective functions exemplified below.

f1:=99.0424978610709132−6.83556672325811121*x1+14.0478279657713 188*x2 −18.6265540605823148*x3−28.3737252180449389*x4 −2.42724827545463118*x5+36.9188200131846998*x6−46.762070412 8296296*x7 +1.05958887094079946*x8+6.50858043416747911*x9−11.318111074 5759242*x10 −6.35438297722882960*x11+4.85313298773917622*x12−11.1428988 07281405*x[13]+35.3305897914634315*x14−53.2729720194943113*x15; [Mathematical expression 2]

In this case, there is a tendency in a slider design that as work advances, the types of input parameters become many. It is anticipated that there are parameters whose contribution to a certain objective function is low, due to the influence of other parameters. Therefore, approximation by easier polynomial can be made possible by incorporating a routine for excluding the parameters whose contribution to a certain objective function is low by a multiple regression analysis into the process. When a designer inputs the number of parameters used for analysis, the objective function polynomial approximation unit 102 reduces the number of parameters up to the number of the setting. By this parameter reduction process, the amount of calculation at the time of calculation by the QE method which will be described can be reduced.

As this result, the polynomial of objective functions the number of whose parameters is reduced as exemplified below can be obtained.

f1 :=100.236733508603720−.772229409006272793*x1−20.7218054045105 654*x3 −5.61123555392073126*x5+27.4287250065600468*x6−52.620921922 8864030*x7 +2.86781289549098428*x8−1.51535612687246779*x11−51.15372868 23153181*x15; [Mathematical expression 3]

(Number of variables are reduced from 15 to 8)

As described above, in the preferred embodiment of the present invention, an objective function approximated using a polynomial by a multiple regression expression can be obtained, using at most several hundreds of input parameter sample sets 107. It is because in a slider design, at first there is the initial shape of a slider and optimization is performed while sweeping parameters for determining this initial shape within a specified range that an objective function can be approximated by using a polynomial. It is because in such a local design modification range, sufficiently effective optimization can be made by linear approximation by a multiple regression expression.

In the preferred embodiment of the present invention, by using an objective function calculated and mathematically processed thus in the former stage of slider design, in particular, for the determination of a Pareto boundary, a very efficient design support system can be realized.

Specifically, the QE calculation unit 103 shown in FIG. 4 calculates arbitrary two or more inter-objective function logical expressions by the QE method on the basis of each objective function polynomial calculated by the objective function polynomial approximation unit 102 and the constraint of each parameter value of the input parameter sample sets 107 (input parameter sets 108)(a part of step S204 in FIG. 5).

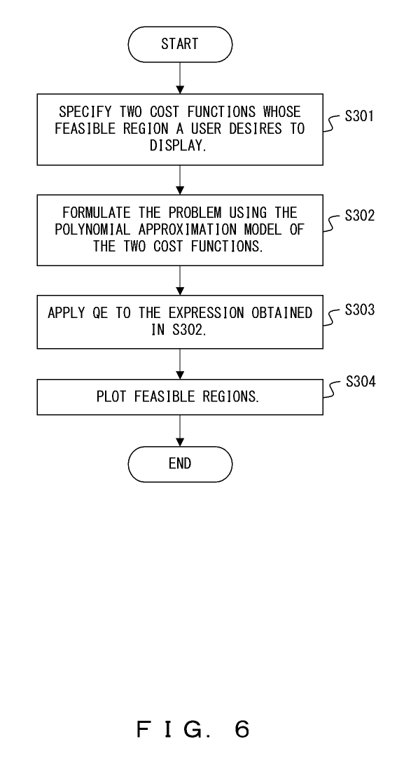

The algorism of the QE method in step S204 is described below according to the operational flowchart shown in FIG. 6.

Firstly, a user specifies two objective functions whose usable area is desired to display (step S301 in FIG. 6). It is assumed that these are f1 and f2. A preferred embodiment in which three objective functions are specified is also possible.

Then, the QE calculation unit 103 formulates the problem using the approximation polynomial of two or more specified objective functions calculated by the objective function polynomial approximation unit 102 and constraint of each parameter value of the input parameter sample sets 107 (input parameter sets 108) (step S303 in FIG. 6). Thus, for example, a formulation as exemplified below can be obtained. Although in this example, the number of parameters is 15 and is not reduced, it can also be reduced.

y1=ƒ1(x1; . . . , x15),y2=ƒ2(x1; . . . , x15)

F:=∃x1∃x2 . . . ∃x15;0≦x1≦1 and 0≦x2≦1 and . . . and 0≦x15≦1

and y1=ƒ1(x1; . . . , x15) and y2=ƒ2(x1; . . . , x15) [Mathematical expression 4]

Input parameters x1, . . . , x15 moves between 0≦x_i≦1.

Then, the QE calculation unit 103 solves the formula F exemplified as Mathematical expression 4 according to the QE method (step S303 in FIG. 6). As this result, input parameters x1, . . . , x5 as exemplified below are eliminated and the logical expression of two objective functions y1 and y2 is outputted. In the case where the number of objective functions is three, the logical expressions of three objective functions y1, y2 and y3 are outputted.

y2<y1+1 and y2>2 and y2>2*y1−3 [Mathematical expression 5]

Although the details of the QE method are omitted here, its processing method is disclosed in a publicly known literature by the inventors, Hirokazu Anai and Kazuhiro Yokoyama, of this application, “Introduction to Calculation real algebraic geometry: Summary of CAD and QE” (Mathematic Seminar, No. 11, pp. 64-70, 2007) and the processing method is also used without any modification in the preferred embodiment of the present invention.

Then, the usable area display unit 104 shown in FIG. 4 displays the usable areas of two objective functions on a computer display on the basis of arbitrary two inter-objective function logical expression calculated by the QE calculation unit 103 (step S204 in FIG. 5 and step S304 in FIG. 6).

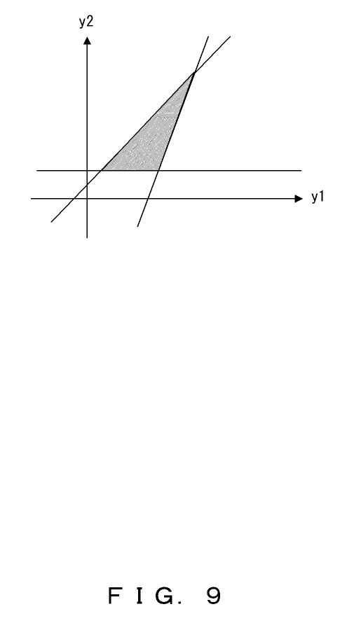

Specifically, the usable area display unit 104 consecutively paints over points in which the logical expression of two objective functions y1 and y2 that is calculated by the QE calculation unit 103 and exemplified as Mathematical expression 5 holds true while sweeping each point on a two-dimensional plotting plane of the two objective functions y1 and y2. As this result, a usable area can be displayed, for example, in the form shown as the painted area in FIG. 9.

In the case where the number of objective functions is three, it is displayed three-dimensionally.

Another detailed example of the usable area display process is described below.

It is assumed that the approximation polynomial of two objective functions is composed of three input parameters x1, x2 and x3, as exemplified below.

y1=f1(x1, x2, x3)=x1−2*x2+3*x3+6

y2=f2(x1, x2, x3)=2*x1+3*x2−x3+5 [Mathematical expression 6]

When Mathematical expression 6 is formulated, the following expression is obtained.

F:=∃x₁∃x₂∃x₃; 0≦x₁≦1 and 0≦x₂≦1 and 0≦x₃≦1 and y₁=x₁−2x₂+3x₃₊₆ and y₂=2x₁+3x₂−x₃+5 [Mathematical expression 7]

When the QE method is applied to Mathematical expression 7, the following expression is obtained.

(3*y1+2*y2−35>=0 and 3*y1+2*y2−42 <=0 and y1+3*y2−28>=0 and y1+3*y2−35<=0)

or (3*y1+2*y2−28>=0 and 3*y1+2*y2−35<=0 and 2*y1−y2−7<=0 and 2*y1−y2>=0)

or (2*y1−y2−7>=0 and 2*y1−y2−14<=0 and y1+3*y2−21>=0 and y1+3*y2−28<=0) [Mathematical expression 8]

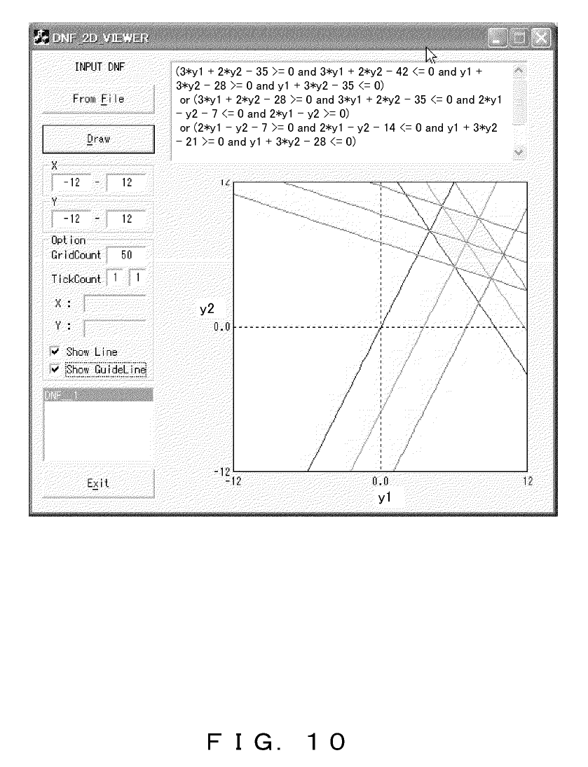

When a usable area is plotted on the basis of Mathematical expression 8, for example, one as shown in FIG. 10 can be obtained. In FIG. 10, an oblique straight line indicates each logical boundary of Mathematical expression 8 and painted area is the usable area of the two objective functions.

As clearly known from FIG. 10, in the painted usable area the Pareto boundary of the two objective functions can be easily recognized intuitively as the boundary of a lower edge near the coordinate origin and the limit area of optimization can be recognized. In the case of three objective functions, although a Pareto boundary becomes a curved surface (Pareto curved surface), it can be three-dimensionally displayed.

When calculating the single objective function of a weighted sum (see Mathematical expression 1) on the basis of two objective functions, the optimum value of the ratio of each weight value between the two objective functions in weight vector can be estimated by recognizing the overall inclination of the usable area.

Although in this case, it is assumed that in Mathematical expression 7, each input parameter constituting the input parameter sample sets 107 can freely take any number between 0 and 1, actually it is anticipated that if it is searched for in such a way as to specify the center point of an input parameter and to move the value in a certain range, a better result will be able to be obtained.

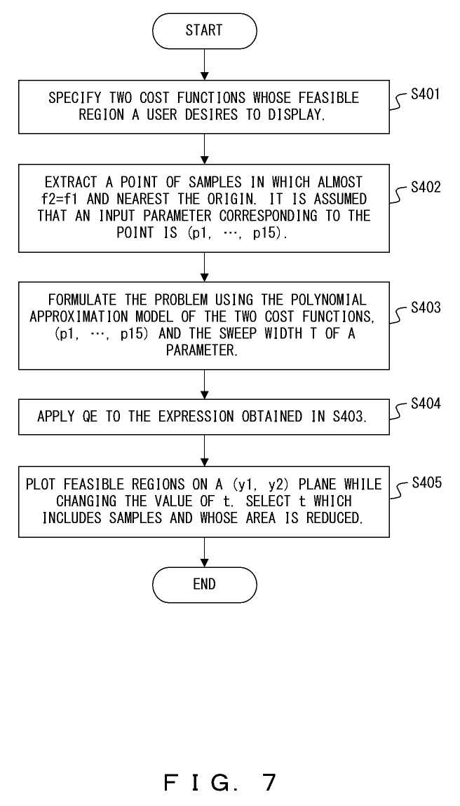

In order to enable such an operation, in step S204 in FIG. 5, the QE calculation unit 103 and the usable area display unit 104 which are shown in FIG. 7 implements the operational flow chart instead of the operational flowchart in FIG. 6.

Firstly, a user specifies two objective functions whose usable area is desired to display (step S401 in FIG. 7). It is assumed that these are f1 and f2.

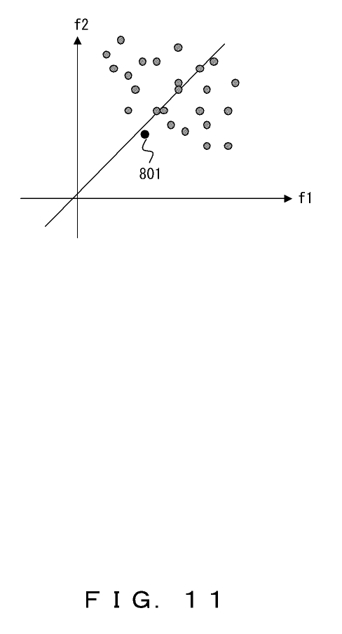

Then, the QE calculation unit 103 extracts a point among the input parameter sample set 107 and two specified objective functions (f1 and f2) corresponding it, in which almost f2=f1 and also is nearest the origin, for example, a point represented by 801 in FIG. 11. It is assumed that input parameters corresponding to it are (p1, . . . , p15) (step S402 in FIG. 7).

Then, the QE calculation unit 103 formulates the problem using the approximation polynomial of the two specified objective functions calculated by the objective function polynomial approximation unit 102 and the sweep width t of each parameter value of the input parameters sample sets 107 (input parameter sets 108) (step S403 in FIG. 7). Thus, for example, a formulation as exemplified below can be obtained.

F:=∃x1∃x2 . . . ∃x15; p1−t≦x1≦p1+t and p2−t≦x2≦p2+t

and . . . and p15−t≦x15≦p15+t

and y1=ƒ1(x1; . . . , x15) and y2=ƒ2(x1; . . . x15) [Mathematical expression 9]

Each input parameter x_i moves between width t around p_i.

Then, the QE calculation unit 103 solves the value F of an expression as exemplified as Mathematical expression 9 according to the QE method (step S404 in FIG. 7). As this result, the input parameters x1, . . . , x5 are eliminated and the logical expression of two objective functions y1 and y2 and the sweep width t is outputted.

Then, the usable area display unit 104 in FIG. 4 displays the usable area of the two objective functions on a computer display while modifying the value of the sweep width t on the basis of the logical expression between arbitrary two objective functions calculated by the QE calculation unit 103 (step S405 in FIG. 7).

In this case, it is preferable to select t in such a way as to include the input parameter sample set 107 and also to reduce its area.

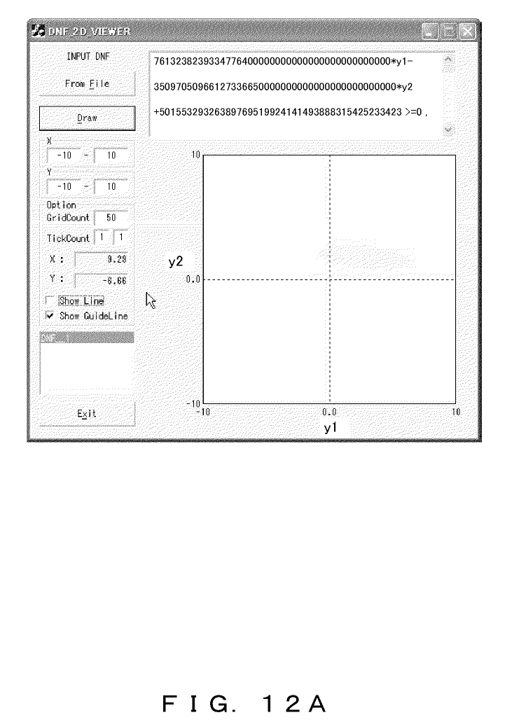

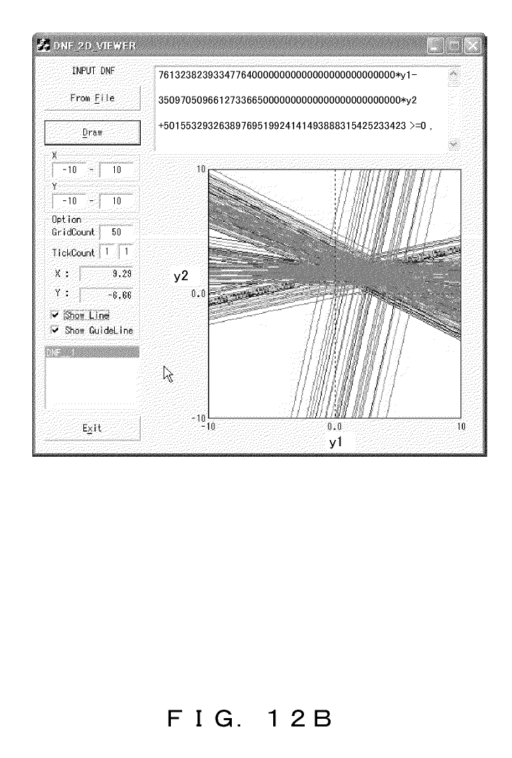

FIG. 12A is an example of the usable area display obtained by using input parameter sample set 107 corresponding to an actual slider shape. FIG. 12B is an example of the usable area display in the case where the boundary of the logical expression is also displayed. In this example, it is a graph in which the amount of slider flying in a low altitude (0 m) is a first objective function f1, the amount of slider flying in a high altitude (4200 m) is a second objective function f2, and their relations are y1 and y2.

Since the inclination of a Pareto curve in this graph is approximately −⅛˜−⅕, it is sufficient if the ratio of a weight value in a weight vector in the case where these two objective functions are weighted and a single objective function (see Mathematical expression 1) is obtained is approximately 1 vs. 8˜1 vs. 5.

Thus, in the process of the usable area display unit 104 shown in FIG. 4, the user can estimate a weight value in a weight vector in the case where optimization by a single objective function (see Mathematical expression 1) is anticipated (step S205 in FIG. 5). The user can notify the system of the ratio of the weight value of a weight vector, for example, by instructing not to in particular show the overall inclination of the usable area on the display in the drawing and the like. Alternatively, the system can automatically detect the ratio of a weight value according to prescribed algorithm.

In the above usable area display process, the user can efficiently specify a ratio of a weight value of a weight vector, a Pareto boundary for each objective function while sequentially specifying two objective functions.

After the above operation, the single objective function optimization unit 105 computes the single objective function value (see Mathematical expression 1) obtained as the weighted linear sum of objective functions of the input parameter sets 108 on the basis of each objective function polynomial calculated by the objective function polynomial approximation unit 102 and the ratio of a weight value in the weight vector determined by the user on the usable area display unit 104 and calculates an input parameter set 108 candidate whose single objective function value becomes a minimum (step S207 in FIG. 5). The number of the input parameter sets 108 is approximately 10,000˜20,000.

In this case, since in the calculation of each objective function value, an approximation polynomial is used instead of actually conducting a flying calculation, it can be calculated in a very high speed. Furthermore, since for a weight value group in a weight vector used when calculating a single objective function value on the basis of Mathematical expression 1, a value appropriately specified by the user in the operation of the usable area display unit 104, there is no need of repetitious calculation, such as consecutively modifying a weight vector.

Lastly, the actual flying calculation optimization unit 106 shown in FIG. 4 applies a detailed flying calculation to the input parameter set 108 candidate whose single objective function value calculated by the single objective function optimization unit 105 and calculates a single objective function value obtained as the weighted linear sum of objective functions (step S208 in FIG. 5). In this case, for each objective function, one obtained from an actual flying calculation is used and for the weight vector, the same one used in the single objective function optimization unit 105 or one obtained by modifying it somewhat is used.

Then, the actual flying calculation optimization unit 106 determines whether the optimization of this single objective function value and each then objective function value converges, referring to the limit value of the objective function, anticipated in the earlier-described usable area display process (step S209 in FIG. 5).

If the optimization does not converge yet and it is determined the determination in step S209 is no, the flow returns to step S207 and the weight value in the weight vector is somewhat modified. Then, the optimization process in steps S207 and 208 are performed again.

When the optimization converges and the actual flying calculation optimization unit 106 determines yes in the determination in step S209, an input parameter set 108 whose single objective function value obtained then becomes a minimum is outputted as an optimum slider shape parameter set 109 (step S210 in FIG. 5).

Next, another preferred embodiment of the operation of the QE calculation unit 103 and the usable area display unit 104 is described below.

In the operations of the above QE calculation unit 103 and the usable area display unit 104 shown in the operational flowchart in FIG. 7, a logical expression F is formulated in such a way that, for example, one point of the two objective functions (f1 and f2) in which is almost f2=f1 and which is nearest the origin, for example, a point represented by 801 in FIG. 11 can be specified as the center point of the input parameter and an usable area can be searched for in the range of motion width t using the one point as the center.

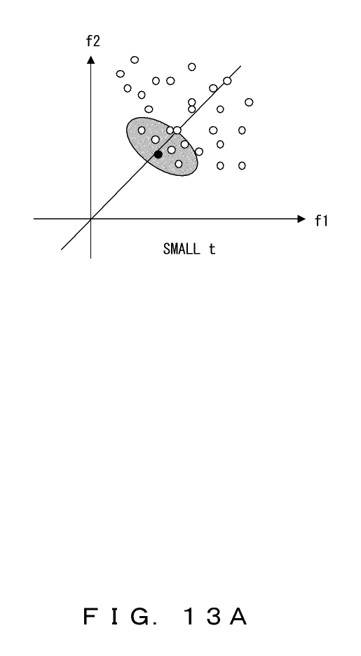

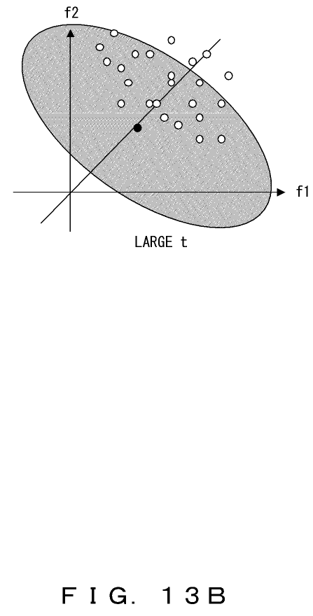

In the case where a usable area is displayed on the basis of the logical expression F determined thus, as shown in FIGS. 13A, when plotting, as the motion width t is reduced, the range of the usable area becomes small, and as shown in FIG. 13B, as the motion width t is increased, the range of the usable area becomes large. In this case, it is preferable for the usable area to include input parameters as accurately as possible and to be large in that the selection range of design parameters can be extended and the freedom of design can be improved.

However, as shown in the operational flowchart shown in FIG. 7, when a usable area is probed using one point of the input parameter as the center, as shown in FIG. 13A, if the motion width is small, the range of the usable area becomes small although the usable area almost accurately includes the input parameters. Conversely, if the motion width is large, the usable area does not accurately include the input parameters although the range of the usable area becomes large. In other words, in a method for probing a usable area using one point of the input parameter as the center, it is difficult to find a motion width that fits a sample set, which is a problem.

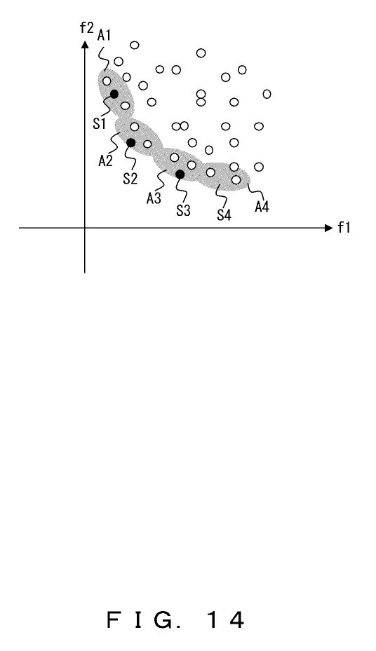

Therefore, in a preferred embodiment described below, instead of searching for a usable area using only one point of the input parameter as the center, as shown in FIG. 14, a plurality of points in the vicinity of the Pareto boundary, for example, four points of S1, S2, S3 and S4 are used as the center, the motion width t is set in such a way as to fit each of the points and usable areas A1, A2, A3 and A4 corresponding to each of them are searched for. A plurality of usable areas obtained thus are combined and displayed. Thus, a usable area which accurately includes input parameters and also widely extends on the Pareto boundary can be searched for.

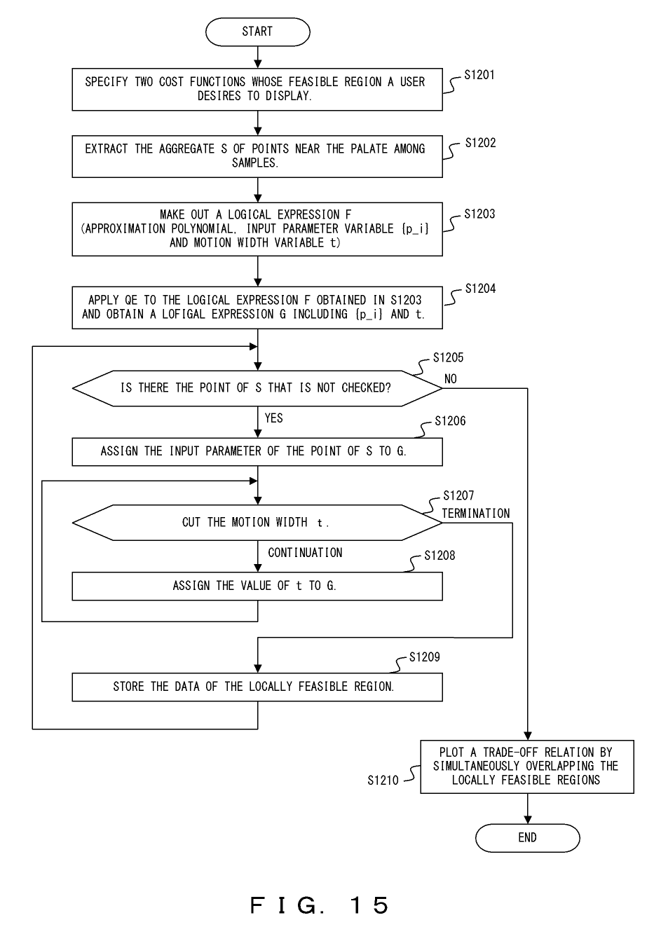

FIG. 15 shows the operations that the QE calculation unit 103 and the usable area display unit 104 perform in step S204 in FIG. 5 in order to realize the above-described functions instead of the operational flowchart shown in FIG. 7.

Firstly, a user specifies two objective functions whose usable area is desired to display (step S1201 in FIG. 15). It is assumed that they are f1 and f2.

Then, the QE calculation unit 103 shown in FIG. 4 extracts a center point set S near the Pareto, for example, four center points of S1, S2, S3 and S4 shown in FIG. 14, of input parameter sample sets 107. Specifically, this center point set S is extracted on a plane specified by two objective functions (f1 and f2) as a set of sample points arrayed in equal intervals in the vicinity of the side end near the origin shown in FIG. 14.

Then, the QE calculation unit 103 formulates the problem using the approximation polynomial of two specified objective functions calculated by the objective function polynomial approximation unit 102, a center point input parameter variable {p₁i}=(p1, . . . , p15) expressing the input parameter of each center point included in the center point set S by a variable and motion width t (the same t as shown in FIG. 7) thereby to make out a logical expression (step S1203 in FIG. 15). Thus, for example, the following formulation exemplified as Mathematical expression 9 can be obtained. Although in the above description of FIG. 7, (p1, . . . , p15) means the coordinates of one specific center point, in this preferred embodiment, it means a variable expressing a plurality of center points.

Then, the QE calculation unit 103 solves the value F of an expression exemplified by Mathematical expression 9 according to the QE method (step S1204 in FIG. 15). As this result, the input parameters x1, . . . , x15 are eliminated and the logical expression G of two objective functions y1 and y2, a center point input parameter variable {p₁i} and a motion width t can be outputted.

Then, the QE calculation unit 103 performs the processes in steps S1206˜S1209 while selecting each center point included in the center point set S, for example, S1, S2, S3 and S4 shown in FIG. 14 one by one in the determination in step S1205 shown in FIG. 15.

Firstly, the QE calculation unit 103 assigns an input parameter corresponding to the selected center point to the center point input parameter variable {p_i}=(p1, . . . , p15) of the logical expression G calculated in step S1204 (step S1206 in FIG. 15).

Then, the QE calculation unit 103 calculates a usable area corresponding to the currently selected center point by repeating a process of assigning the value of a cut motion width t to the logical expression G obtained in step S1206 in step S1208 shown in step S1208 while sequentially cutting the value of the motion width t in the determination process in step S 1207 shown in FIG. 15 and calculating the value.

When determining that the process of cutting the motion width t in a prescribed range in step S 1207 shown in FIG. 15, the QE calculation unit 103 stores the usable area calculated as described above in relation to one selected center point in memory and the like as a locally usable area.

The QE calculation unit 103 applies the process of calculating a locally usable area corresponding to one center point indicated by steps S1206-S1209 shown above in FIG. 15 to all the center points included in the center point set S, for example, S1, S2, S3 and S4 shown in FIG. 14 via the determination of step S1205 shown in FIG. 15.

Then, if in step S1205 shown in FIG. 15 it is determined that the calculation process of a locally usable area of all the center points included in the center point set S, the usable area display unit 104 shown in FIG. 4 simultaneously overlaps each locally usable area corresponding to each center point included in the center point set G that is stored in memory and the like, for example, usable areas A1, A2, A3 and A4 corresponding to S1, S2, S3 and S4, respectively, shown in FIG. 14 and display them on a computer display (step S 1210 in FIG. 15). Thus, the user can clearly catch the trade-off relation between the selected two objective functions.

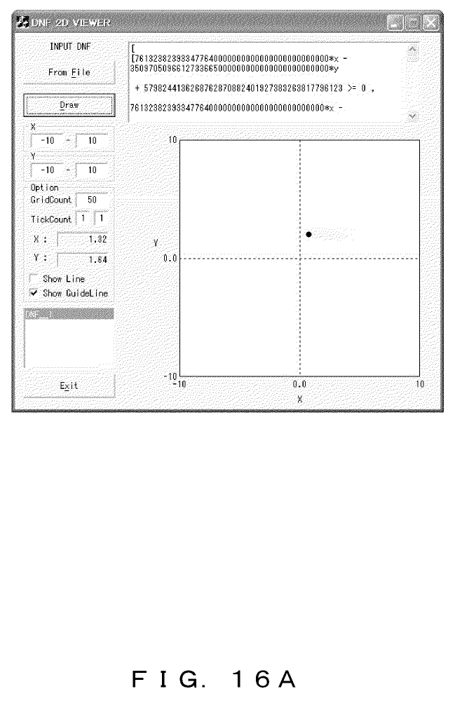

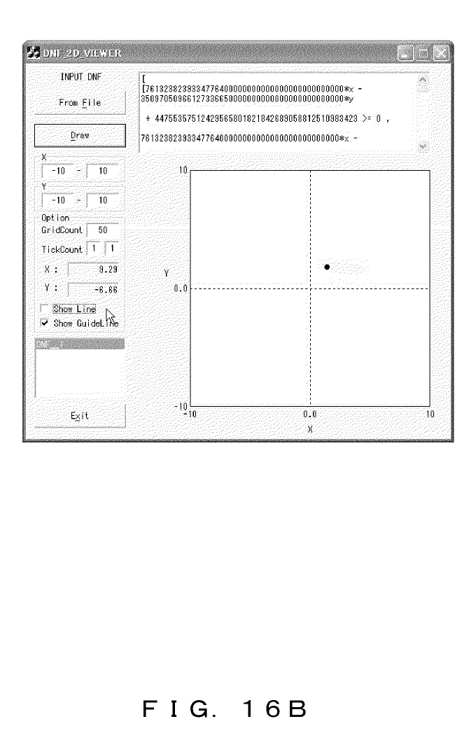

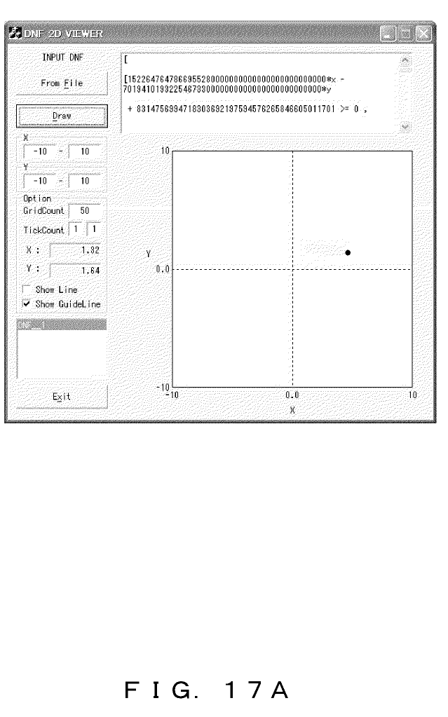

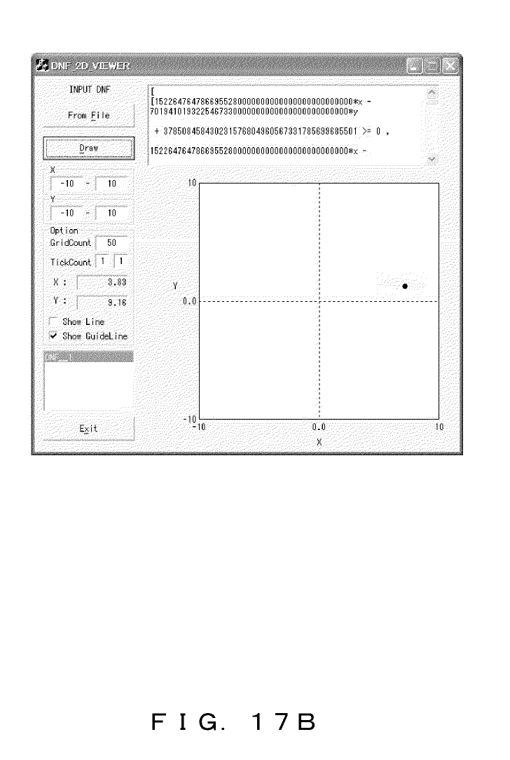

FIGS. 16A and 16B and 17A and 17B are examples of the combination of four pieces of usable area display obtained by specifying four center points.

As described above, in the above preferred embodiment, by improving the accuracy of the locally usable area configuration by reducing the motion width t somewhat, applying it to many points and overlapping the obtained accurate usable area at each point, the accuracy of a global Pareto configuration can be improved.

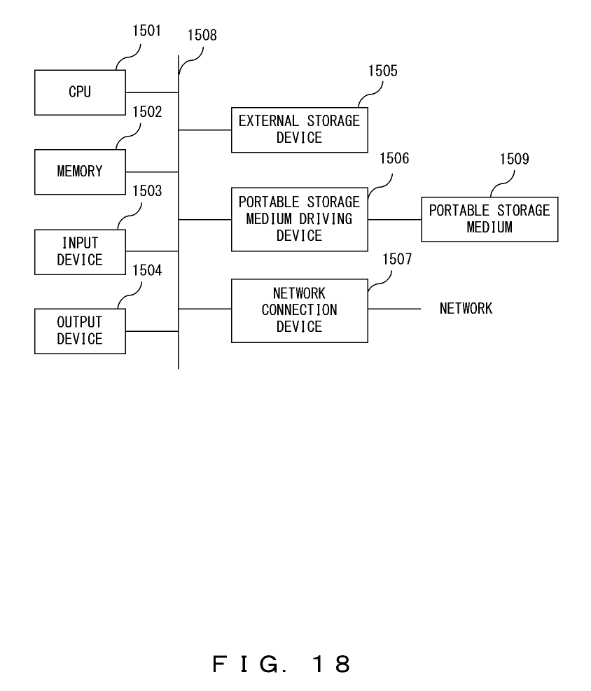

FIG. 18 shows one example of the hardware configuration of a computer capable of realizing the above-described system.

A computer shown in FIG. 18 comprises a central processing unit (CPU) 1501, memory 1502, an input device 1503, an output device 1504, an external storage device 1505, a portable storage medium driving device 1506 in which a portable storage medium 1509 is inserted and a network connection device 1507, which are connected to each other by a bus 1508. The configuration shown in FIG. 18 is one example of a computer capable of realizing the above-described system and this configuration is not limited to such a computer.

The CPU 1501 controls the entire computer. The memory 1502 is RAM for temporarily storing programs or data stored in the external storage device 1505 (or the portable storage medium 1509)when executing a program, updating data and the like, and the like. The CPU 1501 controls the entire computer by reading a program in the memory 1502 and executing it.

The input device 1503 comprises, for example, a keyboard, a mouse and the like and their interface control device. The input device 1503 detects an input operation by a user using the keyboard, the mouse or the like and notifies the CPU 1501 of the detection result.

The output device 1504 comprises a display, a printer and the like and their interface control device. The output device 1504 outputs data transmitted under the control of the CPU 1501 to the display and the printer.

The external storage device 1505 is, for example, a hard disk storage device. The output device 1504 is mainly used to store various types of data and programs.

The portable storage medium driving device 1506 accommodates portable storage media 1509, such as an optical disk, SDRAM, compact flash (registered trademark) and the like and plays an auxiliary role of the external storage device 1505.

The network connection device 1507 connects a communication network, such as a local area network (LAN) or a wide area network (WAN).

A system according to this preferred embodiment can be realized by the CPU 1501 executing a program mounting the functional block shown in FIG. 4. The program can be stored in, for example, the external storage device 1505 or the portable storage medium 1509 and be distributed. Alternatively, the program can be obtained from a network by the network connection device 1507.

Although in the above-described preferred embodiment of the present invention the present invention is used as a design support device for supporting the slider design of a hard disk, the present invention is not limited to this application and can also be applied to various device for supporting design while performing multi-objective optimization.

What is claimed is:

1. A multi-objective optimization design support device using a mathematical processing method, for supporting determination of a set of optimum design parameters by inputting a plurality of sets of design parameters, calculating a plurality of objective functions on the basis of a prescribed calculation and applying a multi-objective optimization process to the plurality of objective functions, comprising:
a sample set objective function calculation unit for calculating the plurality of sets of objective functions of the prescribed sample sets of the design parameters;
an objective function approximation unit for mathematically approximating the objective functions on the basis of the prescribed sample sets of the design parameters and a plurality of sets of objective functions calculated in relation to them;
an inter-objective function logical expression calculation unit for calculating a logical expression indicating a logical relation between arbitrary two or three objective functions, of a plurality of the mathematically approximated objective functions as an inter-objective function logical expression;
a usable area display unit for displaying an area that a value of the arbitrary two or three objective functions can take as a usable area on the basis of the inter-objective function logical expression; and
a design support unit for supporting design on the basis of a display of the usable area.

2. The multi-objective optimization design support device using a mathematical processing method according to claim 1, wherein
the design support unit supports determination of an optimum set of design parameters by limiting the sets of design parameters to the sets of corresponding design parameters in the neighborhood of a Pareto boundary and performing the multi-objective optimization process on the basis of the Pareto boundary of the objective functions recognized from a usable area displayed by the usable area display unit.

3. The multi-objective optimization design support device using a mathematical processing method according to claim 1, wherein
the objective function approximation unit approximates the objective functions by conducting a multiple regression analysis using a polynomial by a multiple regression expression on the basis of the prescribed sample sets of design parameters and a plurality sets of objective functions calculated in relation to them.

4. The multi-objective optimization design support device using a mathematical processing method according to claim 1, wherein
the inter-objective function logical expression calculation unit eliminates variables of the design parameters of arbitrary two or three objective functions, of the plurality of mathematically approximated objective functions by a quantifier elimination method and calculates the inter-objective function logical expression.

5. The multi-objective optimization design support device using a mathematical processing method according to claim 1, wherein
the inter-objective function logical expression calculation unit calculates each of a plurality of the inter-objective function logical expressions in such a way as to separately satisfy each sample set of the design parameters corresponding to each of a plurality of center points in the vicinity of a Pareto boundary of the target objective function, of the sample sets of design parameters and each constraint of each motion width from each of the center point and
the usable area display unit overlaps and displays a plurality of the usable areas on the basis of each of a plurality of the inter-objective function logical expressions calculated by the inter-objective function logical expression calculation unit.

6. The multi-objective optimization design support device using a mathematical processing method according to claim 1 wherein
the design parameters are parameters for determining a shape of a slider unit of a hard disk magnetic storage device.

7. A multi-objective optimization design support method using a mathematical processing method, for supporting determination of a set of optimum design parameters by inputting a plurality of sets of design parameters, calculating a plurality of objective functions on the basis of a prescribed calculation and applying a multi-objective optimization process to the plurality of objective functions, comprising:
calculating the plurality of sets of objective functions of the prescribed sample sets of the design parameters (sample set objective function calculation step);
mathematically approximating the objective functions on the basis of the prescribed sample sets of the design parameters and a plurality of sets of objective functions calculated in relation to them (objective function approximation step);
calculating a logical expression indicating a logical relation between arbitrary two or three objective functions, of a plurality of the mathematically approximated objective functions as an inter-objective function logical expression (inter-objective function logical expression calculation step);
displaying an area that a value of the arbitrary two or three objective functions can take as a usable area on the basis of the inter-objective function logical expression (usable area display step); and
supporting design on the basis of a display of the usable area (design support step).

8. The multi-objective optimization design support method using a mathematical processing method according to claim 7, wherein
in the design support step, an optimum set of design parameters is determined by limiting the sets of design parameters to the sets of corresponding design parameters in the neighborhood of a Pareto boundary and performing the multi-objective optimization process on the basis of the Pareto boundary of the objective functions recognized from a usable area displayed in the usable area display step.

9. The multi-objective optimization design support method using a mathematical processing method according to claim 7, wherein
in the objective function approximation step, the objective functions is approximated by conducting a multiple regression analysis using a polynomial by a multiple regression expression on the basis of the prescribed sample sets of design parameters and a plurality sets of objective functions calculated in relation to them.

10. The multi-objective optimization design support method using a mathematical processing method according to claim 7, wherein
in the inter-objective function logical expression calculation step, variables of the design parameters of arbitrary two or three objective functions, of the plurality of mathematically approximated objective functions are eliminated by a quantifier elimination method and the inter-objective function logical expression is calculated.

11. The multi-objective optimization design support method using a mathematical processing method according to claim 7, wherein
in the inter-objective function logical expression calculation step, each of a plurality of the inter-objective function logical expressions is calculated in such a way as to separately satisfy each sample set of the design parameters corresponding to each of a plurality of center points in the vicinity of a Pareto boundary of the target objective function, of the sample sets of design parameters and each constraint of each motion width from each of the center point and
in the usable area display step, a plurality of the usable areas are overlapped and displayed on the basis of each of a plurality of the inter-objective function logical expressions calculated in the inter-objective function logical expression calculation step.

12. The multi-objective optimization design support method using a mathematical processing method according to claim 7 wherein
the design parameters are parameters for determining a shape of a slider unit of a hard disk magnetic storage device.

13. A computer readable storage medium storing a program for enabling a computer to support determination of an optimum set of design parameters by inputting a plurality of sets of design parameters, calculating a plurality of objective functions on the basis of a prescribed calculation and applying a multi-objective optimization process to the plurality of objective functions, comprising:
calculating the plurality of sets of objective functions of the prescribed sample sets of the design parameters (sample set objective function calculation step);
mathematically approximating the objective functions on the basis of the prescribed sample sets of the design parameters and a plurality of sets of objective functions calculated in relation to them (objective function approximation step);
calculating a logical expression indicating a logical relation between arbitrary two or three objective functions, of a plurality of the mathematically approximated objective functions as an inter-objective function logical expression (inter-objective function logical expression calculation step);
displaying an area that a value of the arbitrary two or three objective functions can take as a usable area on the basis of the inter-objective function logical expression (usable area display step); and
supporting design on the basis of a display of the usable area (design support step).

14. The computer readable storage medium according to claim 13, wherein
in the design support step, an optimum set of design parameters is determined by limiting the sets of design parameters to the sets of corresponding design parameters in the neighborhood of a Pareto boundary and performing the multi-objective optimization process on the basis of the Pareto boundary of the objective functions recognized from a usable area displayed in the usable area display step.

15. The computer readable storage medium according to claim 13, wherein
in the objective function approximation step, the objective functions is approximated by conducting a multiple regression analysis using a polynomial by a multiple regression expression on the basis of the prescribed sample sets of design parameters and a plurality sets of objective functions calculated in relation to them.

16. The computer readable storage medium according to claim 13, wherein
in the inter-objective function logical expression calculation step, variables of the design parameters of arbitrary two or three objective functions, of the plurality of mathematically approximated objective functions are eliminated by a quantifier elimination method and the inter-objective function logical expression is calculated.

17. The computer readable storage medium according to claim 13, wherein
in the inter-objective function logical expression calculation step, each of a plurality of the inter-objective function logical expressions is calculated in such a way as to separately satisfy each sample set of the design parameters corresponding to each of a plurality of center points in the vicinity of a Pareto boundary of the target objective function, of the sample sets of design parameters and each constraint of each motion width from each of the center point and
in the usable area display step, a plurality of the usable areas are overlapped and displayed on the basis of each of a plurality of the inter-objective function logical expressions calculated in the inter-objective function logical expression calculation step.

18. The computer readable storage medium according to claim 13, wherein
the design parameters are parameters for determining a shape of a slider unit of a hard disk magnetic storage device.
